(19) United States
(12) Patent Application Publication
(10) Pub. No.: US 2007/0154009 A1
(43) Pub. Date: Jul. 5, 2007

(54) Systems and methods for audibly indicating incoming telephone calls

(76) Inventors: Kirk Cameron, Portland, OR (US); John Scheck, Vancouver, WA (US)

Correspondence Address: KOLISCH HARTWELL, P.C., 200 PACIFIC BUILDING, 520 SW YAMHILL STREET, PORTLAND, OR, 97204, US

(21) Appl. No.: 11/445,958

(22) Filed: Jun. 2, 2006

Related U.S. Application Data
(60) Provisional application No. 60/756,933, filed on Jan. 5, 2006.

(51) Int. Cl. H04M 1/00; H04M 3/00

(52) U.S. Cl. 379/373.02

(57) ABSTRACT

A landline-telephone personalization system includes a call indicator device, a computer, and a remote server system. The call indicator device is configured to download audio files over a public switched telephone network (PSTN) and a landline-telephone connection to the PSTN and to play one or more audio files to indicate incoming calls through the PSTN over the landline-telephone connection. The computer of the landline-telephone personalization system may include any conventional computer and may be configured to enable a user to view and select one or more audio files available for download to the call indicator device from the remote server system.

### CROSS-REFERENCES

This application claims priority to U.S. Provisional Application Ser. No. 60/756,933 filed Jan. 5, 2006, and entitled “Systems And Methods For Audibly Signaling Incoming Calls,” the entire disclosure of which is incorporated herein by reference for all purposes.

### BACKGROUND

The present disclosure relates generally to devices that play tunes, or audio files, to announce or indicate incoming telephone calls to landline-based telephones. More specifically, the present disclosure relates to devices that download tunes or audio files from a remote server system over a public switched telephone network and that play the downloaded audio files to announce incoming calls.

The telephone plays a central role in many people's lives. It is an important work tool and it is often integral to young people's social lives. Many users have phones near them at nearly all times of the day. These users may want to differentiate their phones and personalize them.

Downloading custom ring tones to cell phones is a very popular way to personalize cell phones. A distinct ring tone allows the users to facilitate the recognition that their phone is ringing. A user also may want to have a distinct ring tone to impress others or for entertainment purposes.

Similar ring tone options currently are not available for home phones using conventional landline telephone systems. Home telephones generally connect to a public switched telephone network (PSTN) via conventional landline telephone lines. Such home telephones are configured to indicate an incoming call through the use of an audible announcement, known as a ring. There are several variations on the home phone rings, short rings, long rings, double rings, etc., but the conventional home phone rings are all variations of the standard jarring ring that has accompanied phones for many decades. The rings used to indicate an incoming telephone call over a landline telephone system are generally not distinctive or customizable. Additionally, conventional home phones, or other phones adapted to receive calls over the landline telephone system, are not capable of downloading audio files to customize the ring, such as is common for cell phones.

Examples of devices that provide some ring tone functionality to phones other than cell phones are found in Patent Publication Nos. 2004/0109558 A1; 2005/0249336 A1; 2003/0199268 A1 and in UK Patent Application No. GB 2409607. The entire disclosures of these patents and publications are incorporated herein by reference for all purposes.

### SUMMARY

A landline-telephone personalization system includes a call indicator device, a computer, and a remote server system. The call indicator device is adapted to be assigned a first IP address. The call indicator device is also configured to download audio files over a public switched telephone network (PSTN) and a landline telephone connection to the PSTN. The call indicator device is further configured to play one or more audio files to indicate incoming calls through the PSTN over the landline telephone connection.

The computer of the landline-telephone personalization system may include any conventional computer and may include components such as a monitor, a keyboard, processors, drives, and other conventional computer features. The computer is adapted to be assigned a second distinct IP address and may be adapted to communicate with the remote server system over the Internet through the second IP address. The computer is configured to enable a user to view and select audio files available for download to the call indicator device from the remote server system.

The remote server system is configured to establish a TCP/IP connection with the call indicator device using the first IP address over the PSTN. The remote server system is also configured to establish a connection with the computer using the second IP address through an Internet service provider or other means of communicating between two remote computers.

A user of a telephone personalization system within the scope of the present disclosure may use the computer communicating with the remote server system to view the audio files available to the user for download to the user's call indicator device(s). The user may additionally be able to use the computer to select one or more audio files to be downloaded to the user's call indicator device(s). The remote server system may be configured to record or log the audio files selected by the user and to index the one or more selected audio files to one or more of the user's call indicator devices. The selected audio files may then be downloaded to the indexed call indicator devices.

When used to personalize the landline telephone system, the call indicator devices within the scope of the present disclosure are used in association with a landline telephone and connected to the PSTN through a landline telephone line. The call indicator device detects incoming calls from the PSTN to the landline telephone and plays back one or more of the downloaded audio files to indicate the presence of an incoming call.

### BRIEF DESCRIPTION OF THE FIGURES

FIG. 1 is a schematic view of a landline-telephone personalization system for providing customized audible indicators of incoming calls to a landline telephone.

FIG. 2 is a schematic view of a portion of the landline-telephone personalization system of FIG. 1 showing the computer communicating with the remote server system.

FIG. 3 is schematic view of the call indicator device of FIG. 1 operating in a download mode to receive audio files from the remote server system.

FIG. 4 is a schematic block diagram of a call indicator device according to the present disclosure.

FIG. 5 is a flow chart schematically illustrating at least some of the steps in the operation of a call indicator device in a download mode of operation.

FIG. 6 is a flow chart schematically illustrating at least some of the steps in the operation of a call indicator device in a playback mode of operation.

FIG. 7 is a flow chart schematically illustrating at least some of the steps in the operation of a call indicator device in a playback mode of operation including a caller ID module.

FIG. 8 is a schematic view of another implementation of a landline-telephone personalization system including multiple user phones and multiple call indicator devices on one phone line.

FIG. 9 is an exemplary screen shot of a software component viewable on the computer of a landline-telephone personalization system.

### DETAILED DESCRIPTION

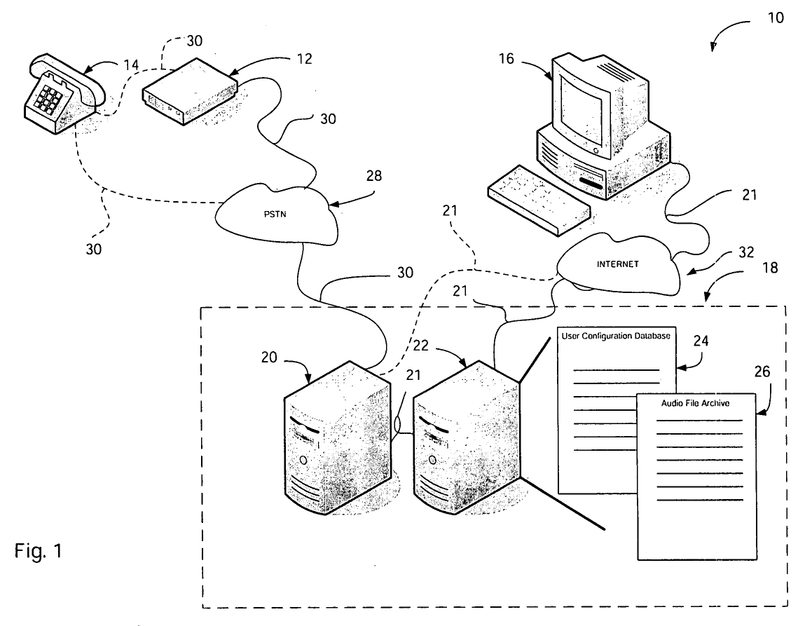

FIG. 1 is a schematic view of a landline-telephone personalization system 10 including a call indicator device 12, a telephone 14, a personal computer 16 and a remote server system 18. Remote server system 18 may include a modem server 20 and an application server 22, as well as other servers and/or components as described herein. The modem server 20 and the application server 22 may be in communication via any suitable communication cable 21 or other communication means. The remote server system 18 may host, or may communicate with computers or servers that host, a user configuration database 24 and an audio file archive 26. The remote server system 18, including the application server 22 and/or the modem server 20, may communicate with the Internet via any suitable communication cable 21 or other communication method.

As illustrated in FIG. 1, the call indicator device 12 communicates with a public switched telephone network (PSTN) 28 via a landline telephone line 30. As used herein, the landline telephone line connection 30 of the call indicator device 12 to the PSTN 28 includes various cables, cords, and other means of connecting the call indicator device 12 to the PSTN 28. However, landline telephone line 30 does not include cellular-type phone connections, Ethernet or broadband connections, or other Internet-based connections that do not pass through a PSTN.

FIG. 1 further illustrates that telephone 14 may be coupled to the PSTN 28 directly through a landline telephone line 30 or may be connected to the PSTN 28 via the call indicator device 12. When connected to the PSTN 28 via the call indicator device 12, the telephone 14 may communicate with the call indicator device 12 via a landline telephone line 30 or through other local communication methods, such as short-range radio, Bluetooth, or other short-range wireless communication means. For example, call indicator device 12 may be provided with the functionality of a telephone in addition to the features described herein and include a wireless transmitter (radio, Bluetooth, or otherwise) to communicate with a telephone 14, a telephone handset, and/or a telephone headset.

Public switched telephone network 28 may include any or all of the features and equipment customary in conventional public switched telephone networks. PSTN's have served the telephone communication needs of users for many years and have evolved over the years. Call indicator devices 12 and the landline-telephone personalization systems 10 of the present disclosure are adapted to communicate via a conventional PSTN 28 and may be adapted to communicate with future modifications and improvements of the PSTN 28. As will be seen herein, call indicator devices 12 are adapted to download audio files through the landline telephone line 30 connection to the PSTN 28 rather than through an Internet connection or through a cellular-type phone connection. The PSTN 28 may connect with the remote server system 18 via a landline telephone line 30.

The remote server system 18 may include any number of suitable hardware and software components to provide it with the functionality described herein. For example, the application server 22 may include one or more servers and may be adapted to host the audio file archive 26 or to communicate with one or more other servers that host the audio file archive 26. Remote server system 18 may additionally include FTP servers, WWW servers, routers, firewalls, and other components. The number and configuration of the components that comprise the remote server system 18 may vary depending on the number of users, the number of transactions, and/or the complexity of the tasks requested of the remote server system. Accordingly, remote server systems of the present disclosure may be configured in any suitable manner to provide the features and services described herein. Additional features and aspects of the remote server system 18 will become apparent from the additional description provided herein below.

With continued reference to FIG. 1, a computer 16 is illustrated as being connected to the remote server system 18 via the Internet 32, by way of suitable communication cable 21 or other communication method. The computer 16 may be any conventional personal computer or computing device capable of viewing web pages and communicating with remote servers over the Internet 32 or other communication system. For example, computer 16 may include conventional PC's, Mac's, or other computer workstations running one or more operating systems and may also include mobile computing devices adapted to communicate with remote servers over the Internet 32, such as handheld devices, cell phones, etc. As used herein, the computer 16 is separate from the call indicator device 12. In some user implementations of the landline-telephone personalization system 10, the computer 16 may be located proximate to the call indicator device 12. In other implementations, the computer 16 may be remote from the call indicator device 12. For example, the call indicator device 12 may be in the user's home and the user may access the remote server system 18 from a computer 16 at another location, such as a work or library computer.

FIGS. 1-3 illustrate features and aspects of the operation and use of the landline-telephone personalization system 10. In summary, the call indicator device 12 is adapted to operate in at least two modes, a download mode and a playback mode. In the playback mode, the call indicator device 12 is adapted to detect incoming calls over the PSTN 28. Upon detection of an incoming call, the call indicator device is adapted to select one or more audio files from the memory of the call indicator device and play the selected audio files to indicate the incoming call. In the download mode of operation, the call indicator device 12 is adapted to establish a connection with the remote server system 18 to download one or more audio files from the remote audio file archive 26. The personal computer 16 is used to interact with the remote server system 18 to enable a user to select what audio files will be downloaded to which call indicator devices when the call indicator device operates in the download mode. Additional details will become apparent in the additional description provided herein.

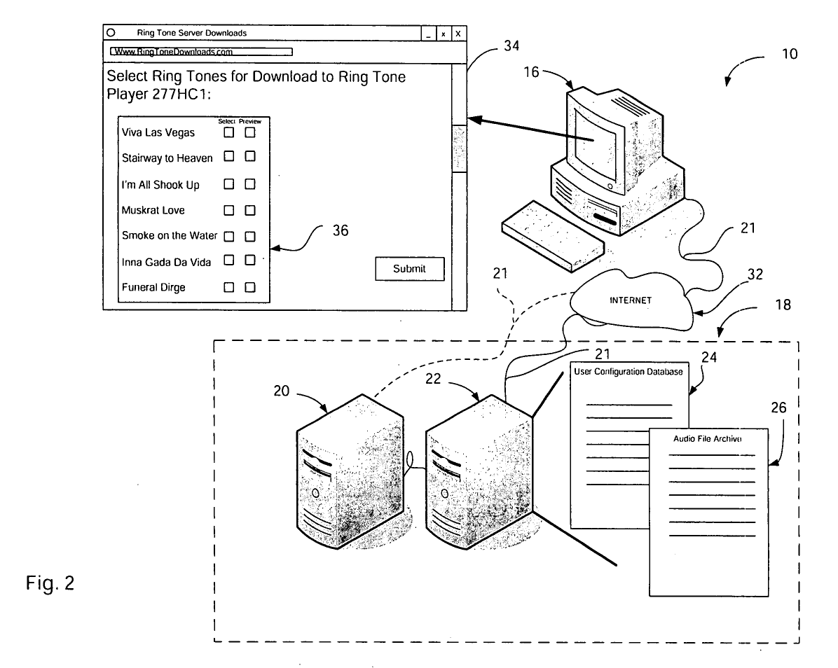

With reference to FIG. 2, portions of the landline-telephone personalization system 10 are illustrated to show the methods through which a user may use the personal computer 16 to interact with the remote server system 18. Specifically, FIG. 2 shows computer 16 connected to remote server system 18 over the Internet 32. The user of the personal computer 16 has accessed a web page 34 from remote server system 18. In some configurations, the remote server system may include an application server 22 adapted to present web pages to users interacting with the remote server system 18. The application server 22 may be configured to display audio files available for download from the audio file archive 26 to the call indicator device 12.

In some embodiments, the application server 22 may be adapted to present web pages that only display songs that are available for download to a particular call indicator device 12 or to a particular user rather than all audio files that might be available to the remote server system. FIG. 2 illustrates one example of such an adaptation. Web page 34 shown in FIG. 2 indicates that the user has registered Ring Tone Player 277HC1 with the remote server system 18. Prior to viewing the page presented in FIG. 2, the user may have taken steps to register one or more call indicator devices 12, or ring tone players, and/or to establish an account with the remote server system 18, including account preferences and permissions. Web page 34 shows a list of audio files 36 that are available for download from the remote server system 18, and particularly from the audio file archive 26. The web page may present the user with a number of options relative to each audio file, such as to preview the file, select the file for download, purchase the file for download, etc. The list of audio files 36 presented to the user may include all of the files available in the audio file archive 26 or may be limited to a subset by any suitable criteria. For example, a particular user may be limited to a certain subset of available audio files based on their subscription services, the configuration of the call indicator device 12, and/or other factors. Additionally, the web page 34 may enable a user to search for audio files by any suitable criteria, such as artist, genre, title, etc. and the list of audio files 36 may be generated by the results of the search.

Once the user selects one or more audio files for download, the selection may be saved by the remote server system. In some configurations, the selections and information input by the user via the web page 34, such as the call indicator device registration number, the audio file selections, etc., may be saved to the user configuration database 24 hosted by or otherwise accessible by the remote server system 18. User configuration database 24 may store the information in any suitable format that enables suitable referencing and cross-referencing of the input information. The information in the user configuration database 24 may be referenced by and accessible to the user when updating a configuration profile and/or audio file selections. Additionally, the user configuration database 24 may be accessed and referenced by the call indicator device 12 when operating in the download mode to determine which audio files to download. Additionally, the user configuration database 24 and the information therein may be referenced and cross-referenced by administrators of the landline-telephone personalization system 10 in maintaining or operating the remote server system 18.

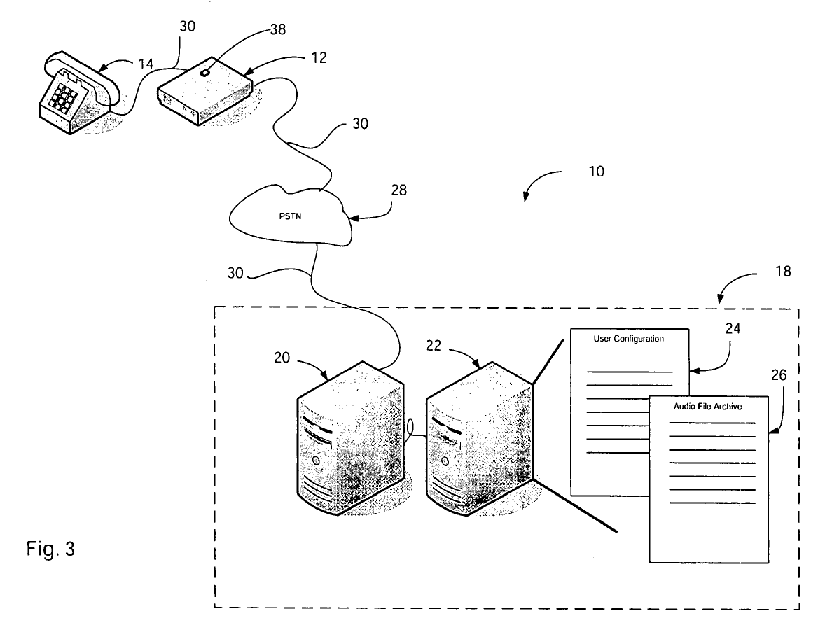

As described above, the call indicator device 12 may have a first mode of operation wherein the call indicator device is adapted to connect to the remote server system 18 to download audio files. The first mode of operation may also be referred to herein as a download mode of operation. FIG. 3 is a schematic view of portions of the landline-telephone personalization system 10 of FIG. 1 with the call indicator device 12 in the download mode of operation. As illustrated, the call indicator device 12 includes a download button 38, which a user may press to operate the call indicator device in the download mode of operation. The call indicator device 12 may include other features to enable a user to initiate the download mode of operation. For example, more than one button may be provided on the call indicator device 12 and the download mode of operation may be initiated upon pressing a particular sequence or combination of buttons. As another example, a user may initiate the download operating mode by dialing one or more predetermined numbers on an associated landline telephone to initiate a connection with the remote server system over the PSTN followed by pressing a predetermined button on the call indicator device to connect the device with the remote server system. Additionally or alternatively, while not shown in FIG. 2, the download mode of operation for a given call indicator device 12 may be triggered or initiated by a user of the computer 16 of the present landline-telephone personalization systems. For example, one or more of the web pages accessed via the connection between the user computer 16 and the remote server system 18 may include an option to enable the user to initiate the download operating mode for one or more call indicator devices 12 for which the user is registered.

After pressing the download button 38 on the call indicator device 12, or otherwise initiating the download operating mode, the call indicator device may dial a preprogrammed number over the PSTN to connect with the remote server system 18, such as to a modem server 20. As described above, the download operating mode may also be initiated remotely from the call indicator device. In such configurations, the remote server system 18 may be adapted to initiate a call to the line on which the desired call indicator device 12 is connected and to send a predetermined signal to trigger the call indicator device to enter the download operating mode. In the event that there are more than one call indicator devices connected to the same telephone line, the signal may include identifiers or other indicators to enable the remote triggering to only initiate the download mode in a desired call indicator device.

Once the call indicator device 12 and the remote server system 18 are connected via the PSTN 28, a TCP/IP connection may be initiated between the remote server system 18 and the call indicator device. Call indicator device 12 may be configured to have an IP address and/or a serial number to enable and facilitate the TCP/IP connection. Additionally or alternatively, the call indicator device 12 may be assigned an IP address by the remote server system 18 and the remote server system 18 may transmit IP address to the call indicator device when the device is connected to the modem server 20. The TCP/IP connection between the call indicator device 12 and the remote server system 18 is established using this IP address, whether provided by the device 12 or assigned by the remote server system 18. As used herein, the TCP/IP connection between the call indicator device 12 and the remote server system 18 is made using an IP address that is distinct from the IP address through which the user interacts with the remote server system when using the computer 16. While the initial connection between the call indicator device 12 and the remote server system 18 is with the modem server 20, the call indicator device may communicate with any one or more servers or other components connected to the remote server system 18 once the TCP/IP connection is established.

While operating in the download operating mode, the call indicator device 12 may download a variety of files from the remote server system 18. To enable the remote server system 18 to know what files to download to which call indicator devices, the remote server system 18 may utilize the distinct IP address of the call indicator device 12, the telephone number from which the device called the remote server system, the serial number of the device, or some combination of these and/or other device or user identifiers. Upon identifying the user and/or the specific call indicator device, the remote server system 18 may reference the user configuration database to determine what files need to be downloaded to the device. In some configurations, the call indicator device 12 may be configured to send data to the remote server system 18 so the remote server system can determine what files are already on the device and compare that to a database of what should be on the device. The remote server system 18 may then download files to the device, delete files on the device, and otherwise manage the data and files stored on the call indicator device 12. As one example, the remote server system 18 may compare the audio files already saved on the call indicator device 12 with those selected by the user via the Internet interface and the computer 16. The remote server system may then download the songs that were selected to be added and delete the songs that were selected to be deleted. The remote server system and the call indicator device may be configured to delete files on the call indicator device and download new files to the device in any suitable order. For example, there may be a synchronization process where particular files are deleted followed by download of the particular files required to complete the current configuration requirement. Additionally or alternatively, the call indicator device may be configured to be reloaded with each connection so that old files are all deleted or overwritten when the new configuration is downloaded. In some configurations, the call indicator device may be capable of both modes and to automatically or selective operate in one or the other mode depending on the number of changes to be made or upon the user preferences.

The remote server system may be adapted to store information about the latest configuration of the call indicator device 12 for troubleshooting the device or for confirming that the user is not selecting more audio files for download than will fit in the storage of the call indicator device. Depending on the status and configuration of the call indicator device, the remote server system 18 may download audio files, firmware updates, programming instructions and indices, or other device configuration files. Additionally, the call indicator device 12 and/or the remote server system 18 may be adapted to validate the files loaded on the device after the download to ensure the integrity of the files.

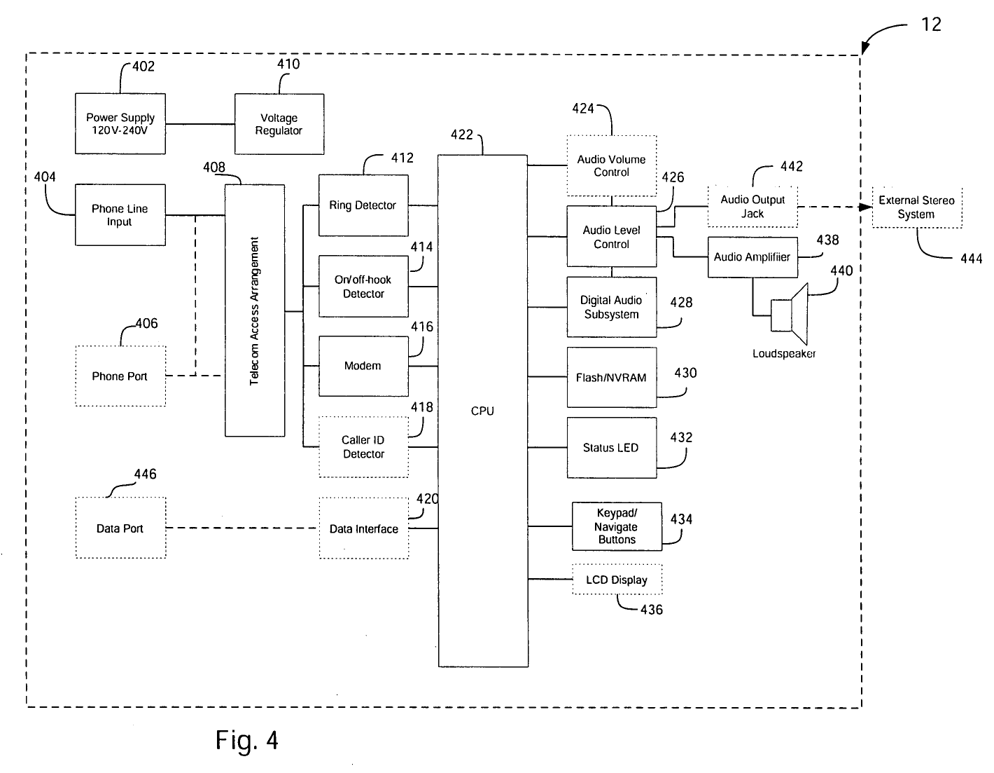

FIG. 4 presents a schematic illustration of an exemplary call indicator device 12. A power supply 402 takes its input power from a standard 120-240 VAC residential power source. Power supply 402 may be auto-ranging where it automatically detects the input voltage and frequency, or it may be designed for a fixed voltage and frequency. Power supply 402 may be external to call indicator device 12 enclosure and connected to device 12 by a low voltage power supply cable. Additionally or alternatively, power supply 402 may be internal to the enclosure of the call indicator device 12 and the cable may be simply a wire or circuit board trace within the device enclosure. A voltage regulator 410 may provide power to components of call indicator device 12 at a variety of voltage levels as required by these components. Other suitable arrangements may be used to provide power to call indicator device 12 or subcomponents thereof. As one example, one or more aspects of call indicator device 12 may utilize some of the low-voltage power provided by the telephone line connection.

Phone line input 404 is a communication port that provides a connection to the incoming telephone line. Optional phone port 406 may be provided to the call indicator device 12 to enable a telephone device to connect the incoming telephone line through the call indicator device 12. The optional phone port 406 may be connected directly to phone line input 404 such that any telephone device connected to the phone port 406 may be able to make and receive calls regardless of whether the call indicator device 12 is powered on or off. The illustrated call indicator device 12 also includes telecom access arrangement 408 that is connected to the phone line input 404 and the optional phone port 406. The telecom access arrangement 408 may be configured to electrically isolate the telephone line from the other components in device 12, which may help to reduce static, feedback, or other undesirable sound effects that otherwise may be passed to the telephone line from the other components of call indicator device 12.

Ring detector 412 is in communication with the phone line input 404 via the telecom access arrangement 408 and is configured to monitor the incoming telephone line for the ring signals sent over the telephone line by the local telephone company. Ring detector 412 communicates with a CPU 422 to provide the CPU 422 with the status of the incoming ring signal, thereby informing the CPU 422 of when a ring signal is present and when it is not, as well as when an incoming ring signal is determined to have stopped. The configuration of the ring detector 412 may vary depending on the other components included in the call indicator device 12. For example, if the call indicator device 12 omits a telecom access arrangement to isolate the telephone line from the other components, the ring detector circuitry and configuration may vary. Additionally or alternatively, the ring detector 412 may be integrated with other components of the call indicator device 12, such as the caller ID detector 418 described below.

Additionally, an on/off-hook detector 414 is in communication with the phone line input 404. Similar to the ring detector 412, the on/off-hook detector 414 may monitor the incoming telephone line. The on/off-hook detector 414 may be adapted to determine if any telephone handsets connected to this telephone line in parallel with the call indicator device 12 are off-hook. The on/off-hook detector is also in communication with the CPU 422 and is adapted to signal the CPU 422 when any handset in parallel with the call indicator device goes off-hook. Accordingly, the on/off-hook detector 414 may be used to signal to CPU 422 that someone has answered the incoming call or is preparing to make an outgoing call. As with the ring detector 412, the circuitry and configuration of the on/off-hook detector 414 may vary according to the other elements included in the call indicator device and may be integrated with other components.

With continuing reference to FIG. 4, the call indicator devices 12 of the present disclosure include a modem 416. The modem 416 may be used to establish a connection with external systems, such as remote server system 18, for the purpose of downloading audio files and/or configuration data from these external systems to the call indicator device directly over a telephone line and the PSTN. The modem 416 may make the connection through a communications port such as phone line input 404. The connection established by the modem 416 may be a TCP/IP connection as discussed elsewhere herein. Data and files downloaded by the modem 416 are passed to the CPU 422, which may be adapted to verify and store the audio files and configuration data. The modem 416 and its operation with the external systems are discussed in greater detail below.

The optional caller ID detector 418 monitors the incoming telephone line for the caller ID information that the local telephone company sends at the start of each call. In call indicator devices 12 that include a caller ID detector 418, the caller ID detector gathers this information once received and sends it to the CPU 422 for processing. Call indicator devices of the present disclosure may be adapted to include one or more additional features or capabilities when a caller ID detector 418 is included, such as described in detail below.

Some embodiments of call indicator devices 12 within the scope of the present disclosure may include an optional data interface 420. The data interface 420 may be used to connect the call indicator device 12 to a personal computer or other device to transfer audio files and configuration data from personal computer 16 to call indicator device 12 and/or for transferring status and configuration data from call indicator device 12 to personal computer 16. This optional data interface 420 may be a direct wired connection through an optional physical data port 421, such as connections that may be used for Universal Serial Bus (USB), Digital Serial, RS232/488, or some other proprietary wired interface, or it may be a wireless interface such as Bluetooth, WiFi 802.11, or some other standard or proprietary wireless interface. Optional data interface 420 may receive commands from CPU 422 and pass data and files to/from CPU 422. Call indicator devices 12 within the scope of the present disclosure that include a data interface 420 may be configured to communicate directly with the remote server system 18 through the modem 416 and the PSTN 28 as described herein to download audio files and configuration data and may also be configured to receive audio files from a personal computer through data interface 420.

CPU 422 may be any of several commercially available processors, such as an Intel 8051 or Motorola MC68; several manufacturers make analogous suitable processors and other processor designs are also acceptable. One or more of the components illustrated in FIG. 4 may be integrated within CPU 422. Additionally or alternatively, CPU 422 may include watchdog timer functions and address/data logic for accessing and communicating with the other devices shown. Several of the functions and operations of the CPU 422 are described in relation to its cooperation with other components. The CPU 422 may include additional features and capabilities depending on the configuration of the call indicator device 12, the arrangement of the components therein, and number and type of components including therein.

An optional external audio volume control 424 may be physically accessible on the outside of the call indicator device 12 enclosure to allow the user to adjust the general audible volume level of the device 12 both upwards and downwards to suit their specific needs. This optional control may be a button or a thumb-wheel or a knob or some other means that changes the volume of device 12. Additionally or alternatively, external audio volume control 424 may communicate directly or indirectly with the CPU 422 and the CPU 422 sets the level of audio output based at least partially on this input signal from the external audio volume control.

An audio level control 426 may directly control the level of audio output. The audio level control 426 receives volume control inputs from the CPU 422 and/or the external audio volume control 424 and audio inputs from a digital audio subsystem 428. The output from the audio level control 426 is fed to the input of an audio amplifier 438, which drives a loudspeaker 440 producing the physical sounds generated by device 12.

An audio output jack 442 may be provided to allow the user to output some or all of the audio signals generated by call indicator device 12 to a separate stereo system or computer audio system 444. Stereo system 444 may be supplied by the user and may provide an increased sound volume or quality than may be available from loudspeaker 440. Audio output jack 442 may be an RCA type plug, a USB port or another component that provides a connection to output audio signals. Audio output jack 442 may be configured to turn off loudspeaker 440 when a plug is mated to it. Alternatively, loudspeaker 440 and stereo system 444 may work simultaneously.

Digital audio subsystem 428 contains the various circuits that decode the digitally stored audio files and convert them to a stream of audio output which can then be amplified by the audio amplifier 438 and played by a loudspeaker 440. Audio level control 426, digital audio subsystem 428, and audio amplifier 438 may be integrated together or integrated with one or more of the other functional blocks within call indicator device 12. One or more of the components of the audio system, such as audio level control 426, the digital audio subsystem, and audio amplifier 438, may be omitted or modified in call indicator devices within the scope of the present disclosure. The components that make up the audio system of the call indicator devices 12 within the scope of the present disclosure, including the audio volume control 424, the audio level control 426, the digital audio subsystem 428, the audio amplifier 438, and the loudspeaker 440, may be configured in a variety of suitable combinations and may include suitable components from a number of available manufacturers. A suitable combination of components will receive a digital audio file from the CPU 422 or a memory source and will decode the digital audio file into an audio output stream that can be played by a speaker to be heard by a user. Additional features and/or functions may be added but are not required.

A flash/NVRAM 430 provides non-volatile memory for call indicator devices 12 and may contain the user's preloaded or downloaded configuration and audio files in a digital format. In some embodiments of call indicator devices 12, at least a portion of flash/NVRAM memory 430 may be removable by the user. For example, device 12 may have a socket into which a user can insert memory. Additionally or alternatively, all of the non-volatile memory 430 may be encased in the call indicator device 12 and not removable and upgradeable by the user. Moreover, in other embodiments, some or all of memory 430 for a call indicator device may include a battery backed RAM or ROM device, either removable or fixed. A removable Flash/NVRAM, if used, may be one of the several standard and commercially available formats (Compact Flash, SmartMemory, Memory Stick, etc.) commonly used in digital cameras and other electronic devices.

A status LED 432 may be connected to and controlled by the CPU 422. The status LED 432 may comprise a plurality of LEDs of different colors controlled such that the different colors represent different states of device 12. For example, a solid green color may indicate power-on-on-hook, a flashing green may indicate the ringing of an incoming call, a yellow color may indicate that one or more telephone handsets is off-hook, a solid red color may indicate a failed power-on self test, and a blinking red color may indicate an error in programming when connected to a personal computer or remote server, etc. The status LED 432 may communicate with the CPU 422 to receive its control signals.

Multiple LED's and/or alphanumeric displays may be incorporated in call indicator device 12. As illustrated schematically in FIG. 4, an optional LCD Display 436 may be located on an external portion of the enclosure to allow call indicator device 12 to provide text and/or numeric information to the user of device 12. The LCD Display 436 may be in communication with the CPU 422, which may determine what messages are displayed and when these messages are displayed.

FIG. 4 also schematically illustrates that call indicator devices 12 within the scope of the present disclosure may include keypad/navigate button(s) 434, which may be disposed externally on device 12 enclosure to allow the user to provide inputs to the call indicator device 12 and to control the device's function. User inputs to the keypad/navigation button(s) 434 may be sensed by CPU 422 which may then determine the appropriate control function to execute based on the specific inputs provided. In some embodiments, keypad/navigation buttons 434 may be adapted to allow a user to configure some or all aspects of device 12's operation directly on device 12. In other embodiments, keypad/navigation buttons 434 may be limited to a single download button adapted to initiate a download routine, such as discussed above.

As discussed above, the audio volume control 424 may include knobs, dials, buttons, or similar user interfaces and may control the output volume without communicating with the CPU 422 or otherwise adjusting the programming of the call indicator device 12. In such configurations, the volume levels adjusted by the audio volume control 424 may affect all audio output by the call indicator device 12. Additionally or alternatively, a software component of the present call indicator devices may provide the means for users to set the overall volume level for device 12. Additionally, the software component may enable a user to set the volume for specific audio announcements to be different than other audio announcements. For example, a call from a known phone number might be announced with a audio announcement that is louder and/or different from the audio announcement that is played when a call from an unknown phone number is received. Similarly, the software component may enable a user to configure the call indicator devices 12 to play audio announcements at one volume level during certain times of the day and lower volume levels during other times of the day, such as when children are sleeping.

FIG. 4 schematically represents one possible configuration of call indicator device 12 with several optional components additionally being represented. Call indicator devices 12 within the scope of the present disclosure may include more or fewer components and/or components that are integrated with other components. A number of suitable components are available to perform each of the functions described schematically above. Call indicator devices 12 within the scope of the present disclosure include any suitable combination of components to provide the functional features described herein.

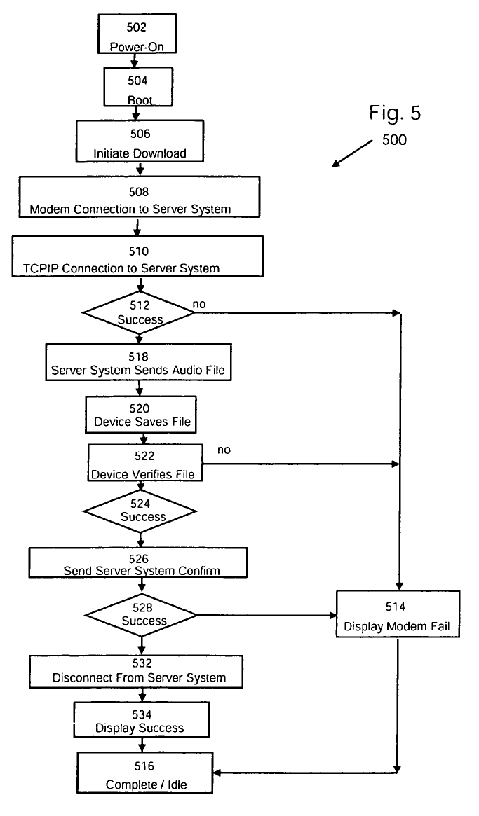

As discussed above, the download mode of operation may be triggered or initiated through a number of different processes and may be triggered locally at the call indicator device 12 or may be triggered remotely at the computer 16. FIG. 5 illustrates a flow chart 500 showing at least some of the possible steps of call indicator device 12 in the operation of downloading a ring tone file or configuration data directly over a telephone line connection from remote server system 18. The initial step 502 is powering on the call indicator device 12. Call indicator device 12 may have a power switch or it may power on when plugged into a power supply. When power is supplied, call indicator device 12 may perform a power-on boot at step 504. After boot, call indicator device 12 may remain in an idle mode and/or a playback mode until a user causes the call indicator device 12 to initiate a download at step 506. The user may initiate a download by pressing a download button 38 or through another suitable process, such as the exemplary alternative processes described for initiating the download operating mode.

In the event that the download operating mode is triggered by pressing a download button 38, the call indicator device 12 may dial one or more numbers in response to pressing the download button on call indicator device 12. The modem 416 of the call indicator device 12 connects to server system 18 at 508. The remote server system 18 and the call indicator device 12 may establish a TCP/IP connection at 510. FIG. 5 illustrates at 512 a test step to determine if the TCP/IP connection is successful. If the connection fails at this step or any subsequent step before the audio file or configuration data is successfully transferred, device 12 may enter the display modem fail step 514. In the display modem fail step 514, the call indicator device 12 may set a visual indicator, such as a flashing red LED or some other visual means, to indicate to the user that the audio file or configuration data download was not successful. Additionally, after completing the display modem fail step 514 or executing the step for a predetermined time, call indicator device 12 may reset, put the modem back on-hook, and enter the idle step 516 wherein the call indicator device 12 is prepared to enter in to the playback mode.

However, if the connection is successful at the modem connects to server system step 508, remote server system 18 may determine the correct audio file and/or configuration data to download based on the originating phone number of the call it received, a serial number, an IP address sent from call indicator device 12 to the server system 18, or some other identifier or combination of identifiers. As described above, the remote server system 18 may reference a user configuration database 24 to determine what audio, data, or configuration files are to be downloaded. Additionally or alternatively, the remote server system 18 may receive information from the connected call indicator device to determine what files need to be downloaded, performing a form of a synchronization with the remote server system 18. Upon determining what files are to be downloaded to the connected call indicator device 12, the remote server system 18 may begin the transmission of the appropriate files to the call indicator device 12 at 518.

Once the audio files and/or configuration data has been completely received, the call indicator device 12 may enter a file save step 520. During the file save step 520, the CPU 422 may direct the communication between the modem 416 and the memory of the call indicator device to properly store the downloaded files. When the file transmissions step 518 and the file save step 520 are completed, the call indicator device 12 may perform a file verification step 522 in which one or more integrity checks are executed to determine whether the transferred and saved files are complete and saved successfully. The result of the file verification step 522 is illustrated at 524. In the event that the file verification step 522 shows that one or more files are not complete, the call indicator device 12 may enter to the display modem failure step 514, as described above, or an analogous procedure to indicate the failure of the download process. However, if the file verification step 522 indicates that the files transferred were correct and complete, then the call indicator device 12 may enter the send confirmation step 526. In the send confirmation step 526, the call indicator device 12 may communicate back to the remote server system 18 that the files were sent and received successfully.

If this confirmation message from the call indicator device 12 to the remote server system 18 fails to be acknowledged at 528, or if the connection between the call indicator device and the remote server system is otherwise lost, then the device 12 may enter the display modem fail step 514 or another suitable and analogous step to indicate to the user that there was a failure. If the transmission of the confirmation is successful and acknowledged by the remote server system 18, then the call indicator device 12 may disconnect from the server at 532 and transition to the modem success step 534. In the modem success step 534, the call indicator device 12 indicates the successful completion of the download operating mode through a visual indicator, such as a flashing green LED, or some other visual means, to indicate to the user that the audio file download has been completed successfully. Additionally or alternatively, the call indicator device 12 may indicate the successful completion of the download operating mode by playing a particular audio file. The call indicator device 12 may then reset and enter the complete/idle 516 step in which the call indicator device is transitioned to the playback mode of operation.

FIG. 5 and the above discussion represent one method of communicating between a local call indicator device 12 and the remote server system 18 to download audio files and/or configuration data directly over the telephone line and the PSTN. One or more of the logic steps described above may be omitted or removed and additional logic steps may be implemented in configuring systems and methods within the scope of the present disclosure. Some of the possible variations are described herein while other suitable variations are possible.

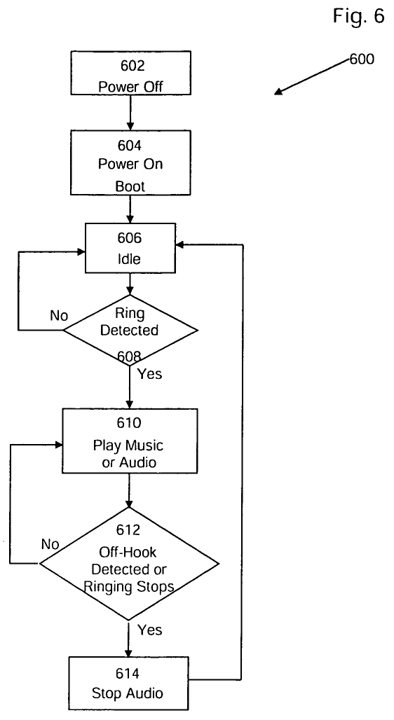

FIG. 6 presents a schematic flow chart 600 showing at least some of the possible steps of a call indicator device 12 according to the present disclosure operating in the playback mode of operation, in which the call indicator device monitors the telephone line for incoming telephone calls and plays an audio file when an incoming telephone call is received. The initial state of device 12 is power off 602, such as when there is no power being supplied to the call indicator device 12 or when the device is turned off. When power is supplied, the call indicator device 12 performs a power-on boot at step 604. The power off, power on, and power-on boot steps described in relation to FIG. 6 may be substantially the same as the analogous steps described above in connection with FIG. 5. Once the call indicator device 12 is turned on, the device may remain in the idle step 606 until a user initiates the download operating mode as described above or until the ring signal of an incoming phone call is detected at step 608. When a ring signal is detected at step 608, the call indicator device 12 may enter a play music/audio step 610. During the play music/audio step 610, the music or audio files are played by the device and may be repeated until either an off-hook condition is detected or a loss of incoming ring signal is detected at step 612. If either of these conditions is met, the call indicator device 12 may move to a stop audio output step 614. In the stop audio output step 614, the call indicator device 12 may stop the audio output, reset itself, and move back into an idle step 606.

FIG. 6 represents a schematic illustration of some of the steps possible in the playback mode of operation. Other suitable steps and features may be provided to the call indicator device 12 during the playback operating mode. For example, the play music/audio step 610 may include playing multiple audio files in a particular order or in a random order while the ring signal persists. As another example, if the ring signal is detected to stop before a telephone is detected to go off-hook to answer the call, the call indicator device may be configured to play an audio file indicating that the call was missed or that the caller hung up prior to entering the stop audio step 614. Additional or alternative aspects of the playback operating mode are described below and still others may become apparent upon a review of the present application; all such aspects and features are within the scope of the present disclosure.

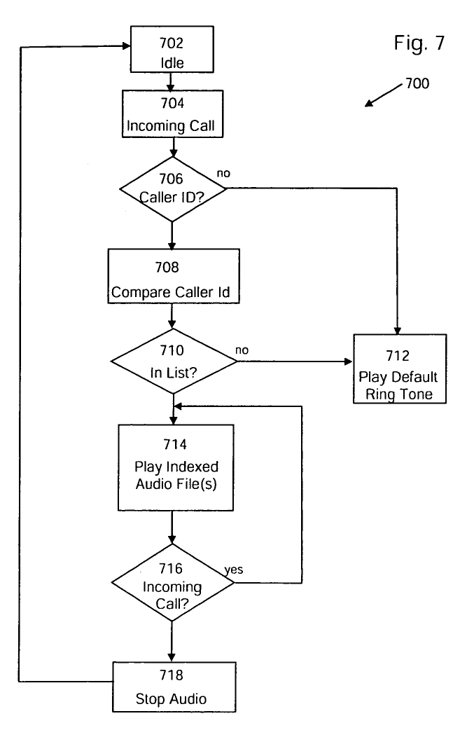

FIG. 7 presents a schematic flow chart 700 for a call indicator device 12 including an optional caller ID detector 418. Call indicator devices 12 that include a caller ID detector 418 may include the capability of reading or determining the calling line ID of an incoming call from the information transmitting by the telephone company when an incoming call is received. The call indicator device 12 may then select one or more particular audio files for playback based at least in part on the determined calling line ID. The schematic flow chart of FIG. 7 shows some possible steps of device 12 in the operation of monitoring the telephone line for incoming telephone calls, determining the calling line ID, and announcing the caller.

Similar to the discussions above, the call indicator device 12 may initially be in a power off state followed by a power-on boot to place the call in an idle state 702. The call indicator-device 12 may remain in the idle state 702 until the ring signal of an incoming phone call is detected. Upon detection of the incoming ring signal, the call indicator device 12 may enter the incoming call step 704. From the incoming call step 704, the call indicator. device may receive and read the incoming caller information that is sent by the telephone service provider and use that information to determine the calling line ID, or caller ID, at step 706. If the call indicator device 12 is unable to determine a caller ID from the incoming caller information, the call indicator device may play a default audio file or ring tone at step 712.

Call indicator devices 12 that include an optional caller ID detector 418 may be configured to include a caller audio database that may be stored in the non-volatile RAM or other memory of the call indicator device. The caller audio database may be adapted to associated specific calling line ID's with specific audio files. When a call is received from a given calling line ID included in the caller audio database, the call indicator device 12 plays one or more audio files that were previously identified and associated with the given calling line ID. For example, the calling line ID of a user's mother may be announced by one audio file or set of audio files while the calling line ID of a user's spouse, boss, mother-in-law, etc. may be announced with a different audio file or set of audio files. The caller audio database may be configured by a user at a computer 16 interacting with the remote server system 18. The database constructed by the user at the computer may then be downloaded to the call indicator device from the remote server system 18 along with the audio files and other configuration data. Additionally or alternatively, the call indicator devices within the scope of the present disclosure may include keypads, buttons, controls, displays or other elements to enable a user to locally associate received calling line ID's with audio files already stored on the call indicator device. The locally stored caller audio database may be configured and added to in other suitable manners.

With continuing reference to FIG. 7, the caller ID detector 418, or caller ID module, determines the calling line ID or caller ID at step 706. The call indicator device 12 may then compare the determined caller ID with the caller ID's stored in the local caller audio database to see if there is a match. If the caller ID of the currently incoming call does not match any caller ID in the caller audio database, then the call indicator device 12 may play a default ring tone or audio file at step 712. Additionally or alternatively, the user may configure the call indicator device 12 to return to the idle state 702 when the incoming caller ID is not found in the caller audio database to screen unwanted calls.

If the caller ID does match one of those in the caller audio database then the call indicator device 12 plays the indexed audio file at step 714. In the play indexed audio file step, the call indicator device 12 may play one or more audio files previously selected by the user and indexed to the caller ID of the currently incoming call. The content of the audio files selected by the user may be customized according to user preferences. In some configurations of the call indicator device 12, the user may be able to select multiple audio files to be played in a particular order or in no order at all. For example, the user may associate a caller ID with a folder of audio files such that an incoming call matching that caller ID would play one or more of the audio files stored in that folder. Additionally or alternatively, the user may associate one or more specific audio files with the caller ID. Additionally or alternatively, one or more caller ID's may be grouped in the caller audio database and associated with the same audio file(s) such that the same audio file selection routine is followed when an incoming call is received from any of those caller ID's.

As indicated above, the audio file(s) played back when a caller ID is found in the caller audio database may include any suitable audio content, including music, spoken announcements, or a combination of the two. The audio files may be recorded locally at the call indicator device 12, may be loaded onto the call indicator device from a computer, and/or may be downloaded from the remote server system 18. Regardless of how the audio file is loaded onto the call indicator device 12 and stored in its memory, the call indicator device 12 may play an audio file including the caller's name, nickname, or some other spoken announcement to indicate the identity of the caller. Additionally or alternatively, the call indicator device 12 may be provided with a text-to-speech functionality that is able to speak the name of the caller as provided in the calling line ID information. In some configurations, the text-to-speech functionality may be configured to play initially followed by an audio file stored on the call indicator device 12.

As indicated above, the audio files played by the call indicator device may be loaded onto the call indicator device in a number of suitable manners, such as downloaded from the remote server system 18, imported from a computer, or locally recorded at the call indicator device 12. For pre-recorded music or audio files, the user may download the audio file from the remote server system 18 or may import from a computer, such as by using the optional data port 446 discussed above. Additionally, the user may be able to create customized audio files for download or import to the call indicator device 12. For example, a user may be able to create a custom audio file using a computer or some other means and then upload that custom audio file to the remote server system 18 for download to the call indicator device 12. Additionally or alternatively, the custom audio file created on the computer may be imported to the call indicator device through a more direct connection to the call indicator device 12. The remote server system 18 may additionally or alternatively provide an interface for a user at computer 16 to customize a pre-recorded audio file stored at the remote server system for later download to call indicator device as a customized audio file, such as by adding speech over music or mixing two or more songs or audio files. Additionally or alternatively, call indicator devices 12 within the scope of the present disclosure may be adapted to enable the user to locally record an audio file, including music and or speech, at the call indicator device 12 and associate the locally recorded file with one or more caller ID's. For example, the user may use a microphone built in to the call indicator device 12 or the call indicator device may be adapted to selectively record sounds spoken into an attached telephone handset. Through the use of visual displays and user interfaces and keypads, the user may be able to assign a file name to the locally recorded audio file and associate the file name with one or more caller ID's for storage in the caller audio database.

With continuing reference to FIG. 7, the call indicator device may remain in the play indexed audio file(s) step 714 either an off-hook condition is detected or a loss of incoming ring signal is detected, which is indicated at step at 718 as determining whether there is still an incoming call. Additionally or alternatively, the call indicator device may be configured to play a preset number of repetitions in the play indexed audio file(s) step before entering the stop audio step. As one example, a user may want to configure the call indicator device to only announce the incoming call for three repetitions of the indexed audio file(s) or for the number of repetitions necessary announce the call for one minute before silencing the call to no longer disturb the user.

When the incoming ring signal is no longer detected, when there is an off-hook condition detected, or when the predetermined maximum repetitions is reached, the call indicator device may enter a stop audio output step 718. In the stop audio output step 718, the call indicator device 12 may stop all audio output, reset itself, and move back into the idle state 702.

Call indicator devices 12 according to the present disclosure may be utilized to provide audio-based announcements, in conjunction with alarm clock functionality, to occur at user-selectable times of the day. In call indicator devices featuring this alarm clock functionality, the call indicator device 12 may be configurable by a user to provide an audible alarm of the user's choosing. This “alarm clock” functionality may be provided by call indicator device 12 as an added functionality to the incoming telephone call announcement functionality described above. Additionally or alternatively, a stand-alone alarm clock may be configured with a phone line port for connecting to a PSTN and a modem for establishing connections with the remote server system 18 to allow a user to configure the alarm clock in a manner analogous to the manner described above for the call indicator device 12. For example, the user may interact with the remote server system via a computer 16 to establish a user configuration profile for a particular alarm clock device that then can be downloaded to the alarm clock from the remote server system. A user may establish a single audio file to be played at all alarm times or may download multiple audio files for selective use for different alarm times.

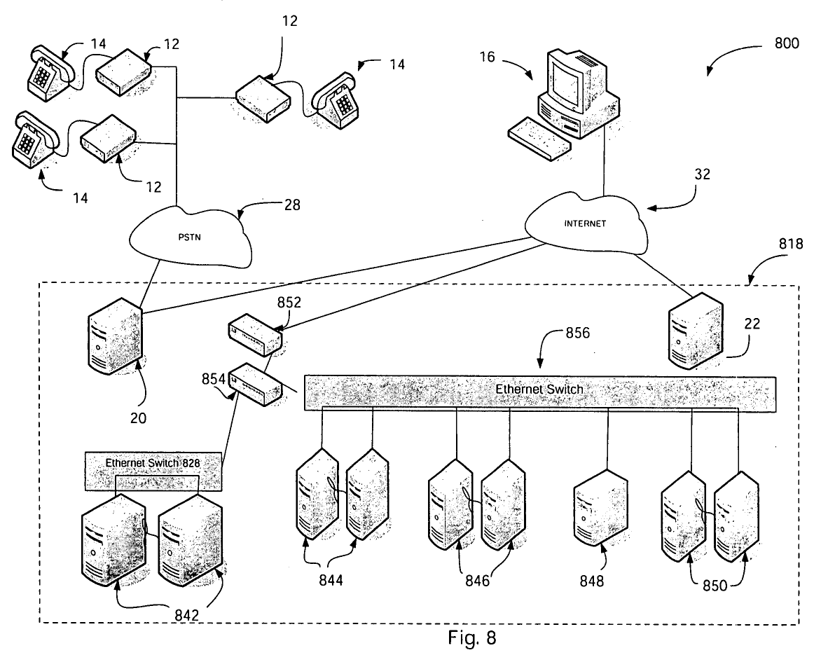

FIG. 8 shows an alternate configuration for a landline-telephone personalization system 800 similar in function to landline-telephone personalization system 10 of FIG. 1. As in FIG. 1, the landline-telephone personalization system 800 may include a computer 16 configured to connect to the Internet 32 through an internet service provider. Similar to the discussion above of FIG. 1, the system further includes three phones 14 and three call indicator devices 12 connected to a public switched telephone network 28 by a single telephone line 30. Also similar to the discussion of FIG. 1, the remote server system 818 may include a modem server 20 and an application server 22. FIG. 8 illustrates that the remote server system 818 may include additional components, such as one or more world wide web servers 842, one or more FTP servers 844, one or more additional application servers 846, one or more database servers 848, and one or more radius servers 850. The remote server system 818 may also include support equipment such as one or more access routers 852, firewall terminations 854, and ethernet switches 856.

The remote server system 818 may be configured to optimize the operation and maintenance of the entire landline-telephone personalization system 800. As discussed briefly in connection with FIG. 1, the hardware and software configuration requirements of the remote server system 818 may change over time as the landline-telephone personalization system 800 changes, such as changes in the call volume, the number of customers, the number of transactions, or the number of audio files accessible by the remote server system. The remote server system 818 may be a single server with all of the above described functions implemented on the single server. Additionally or alternatively, the remote server system 818 may increase the number of servers over time and different functions may migrate between servers to balance loads. The configurations, methods, and procedures presented here are examples and should not be construed as limitations.

Similar to the above discussion, the user may have acquired one or more call indicator devices 12, each identified by an IP address, a serial number, or other unique identifier. The user may access the remote server system 818 and web pages hosted on the web servers 842 through the Internet and an Internet service provider. Through interacting with the web pages, the user may set up an account on the application server 22 referencing the unique identifier of call indicator device 12 or the user may access a previously established account. Once in the account, the user can see the current status of one or more call indicator devices 12, audio files previously selected, and phone numbers indexed to audio files if the call indicator device(s) include the caller ID module. Additionally, through interacting with the web pages, the user may select new audio files for download to the one or more call indicator device and, depending on the configuration of the call indicator device 12, may index audio files and phone numbers to create a caller audio database for each of the one or more call indicator devices. The user configuration data, including account status, current audio file selections, caller audio database, and audio file options may be supported by database servers 848 that store data in a relational database for ease of access and reporting. Additionally or alternatively, the radius servers 850 may provide security features, such as password encryption, userid encryption, and credit card data encryption. Routers 852, firewalls 854, ethernet switches 856, and additional application servers 846 may support various features and functionality to the remote server system, such as access control, purchase and download transaction facilitation and control, and provision of other interactions during user access to the remote server system 818, either via computer 16 or call indicator device 12.

As discussed in connection with both FIGS. 1 and 8, the remote server systems of the present disclosure may include several subcomponents and may change and adapt as the landline-telephone personalization system grows and accommodates more users. Regardless of the configuration of the remote server system, the download procedures and steps may proceed as generally outlined in FIG. 5 and discussed above. Additional or alternatively steps or procedures in the download process may be implemented to enhance the integrity of the system, such as to improve the performance of the call indicator devices and the remote server systems or to improve one or more security aspects of the landline-telephone personalization system. Examples of such additional features, steps, and procedures are described briefly below to illustrate some suitable security or performance measures that implemented in cooperation with the present call indicator devices 12 and remote server systems 18.

As one example of such performance enhancing variations, the remote server system 18 may initiate the download procedure after having a connection established with a call indicator device 12 by sending pre-download configuration instructions to the call indicator device 12. The pre-download configuration instructions may instruct the call indicator device 12 to prepare itself prior to receiving the incoming download file(s). For example, the pre-download configuration instructions may include a series of instructions to move or delete one of more of the audio files that are already stored on device 12, to change configuration settings, or to perform other actions. The user device 12 may perform these changes and then pass back a message to server system 808 indicating that the changes were completed successfully.

The download process may continue with the call indicator device 12 and the remote server system 18 exchanging instructions, requests for instructions, and/or status-updates. For example, the remote server system 18 may instruct the call indicator device to download one or more particular audio files, configuration files, firmware files, or other files from one or more servers within the remote server system or in communication with the remote server system. The instructions to the call indicator devices may include instructions regarding the connection protocols to be used, the server IP addresses and connection ports to be used, the logon instructions and passwords, and/or other information and instructions that may be required to download the files. Additionally, the remote server system may instruct the call indicator device what to do with the file once it has been downloaded.

Depending on the number and type of files that need to be downloaded to the call indicator devices 12, the remote server system may queue the downloads to proceed in a particular order with one or more status checks during the download process. For example, in the event that a firmware update is to be downloaded, the firmware update may be downloaded initially, followed by installation of the firmware update, confirmation that the update was installed correctly, and then proceeding with downloading the remaining audio files needed to be downloaded, if there be any. In configurations where the call indicator device 12 and the remote server system 18 exchange and/or transmit periodic status updates during the download operating mode, the status of the download process may be posted or displayed for a user, either through an online interface with the remote server system or through a status display on the call indicator device. In some implementations of the present systems and methods, all of the download instructions may be downloaded from remote server system at one time and then operated upon by the call indicator device at appropriate times, such as one after another or simultaneously, depending on the nature of the instructions. Additionally or alternatively, the instructions may be downloaded step-wise, one after another, as previous instructions are completed. When all of the audio files and update files have been downloaded, the remote server system may send post-download instructions to the user device 12 with final configuration changes as needed. Watchdog timers on the call indicator device 12 may be used to recover from lock-ups and other failures. The final steps in the download operating mode for some call indicator devices 12 within the scope of the present disclosure may include instructions for the call indicator device to send its updated configuration to the server system. When the remote server system 18 stores a record of the current configuration, including the audio files stored on the call indicator device, the user may be better able to modify the configuration via the computer-based interface with the remote server system at computer 16. The current configuration data may also be used in certain security protocols, as described below.

In some configurations of the landline-telephone personalization systems within the scope of the present disclosure, one or more of the call indicator devices 12 and the remote server systems 18 may be adapted to include software and/or hardware to facilitate download session recovery, such as when a session of the download operating mode terminates prior to completing the required steps. For example, the call indicator device and/or the remote server system may log the status of the download session at the time of the failure and be adapted to restart the download operation at that point when the next download session begins.

Consumers all around the country and all around the world may use the call indicator devices 12 of the present disclosure. The call indicator devices may be pre-programmed or pre-configured with an initial download access telephone number, which number may be the same for all of the devices or may be specific by nation, region, or locality. As one example, all of the devices sold in the United States may be pre-programmed with an initial download access number that is a national toll free number (TFN). Additionally or alternatively, during the first communication session between the call indicator device 12 and the remote server systems 18, the phone number from which the call indicator device 12 is calling in to the remote server system may be used to determine the location of the call indicator device 12. The remote server system 18 may then use this location to determine one or more local download access numbers or other more convenient or appropriate numbers, and to then send these alternative and more appropriate download access numbers to the call indicator device 12 for use in subsequent download sessions. In some implementations, the initial download session may only be as long as required for the local download access numbers to be received by the call indicator device and for the call indicator device to terminate the connection. The call indicator device 12 may then be configured to initiate a subsequent download session by dialing one of the local download access numbers, either automatically or through user interaction. In this way, the operator of the landline-telephone personalization systems may decrease the load on the toll-free number and reduce the costs associated therewith.

Additionally or alternatively, the call indicator devices 12 within the scope of the present disclosure may include a “modem listen” function. A modem listen function may be initiated by holding the “Connect” button, or “Download” button, for a predetermined time, such as 3 or more seconds, when initiating the download. Other key combinations similarly may be used. The modem listen function may enable the modem connection audio to be played through device 12's audio speaker for debugging purposes up to the point that the carrier is detected and the two modems connect, at which point the audio is cut silent.

An operator of the landline-telephone personalization systems according to the present disclosure may be concerned about the security of the remote server system. Additionally, the operators may be concerned about users or others downloading music or other audio files to unauthorized devices or using the audio files in manners beyond the scope of the copyright license granted to the users. A number of security measures may be implemented in different suitable combinations to improve the integrity of the telephone personalization system.

In one exemplary security measure, the modem server 20 of the remote server system may create an L2TP tunnel from the incoming modem of the call indicator device to an L2TP termination device within the remote server system. The use of a termination device may enable the operator of the remote server system to limit the incoming modem connections to communications with only the “internal” network segment. Accordingly, the users dialing in to the modem server of the remote server system will not be able to gain access to the broader, external Internet through the connection to the modem server. As one example of the benefit of this security measure, users at computers will not be able to use the download access phone number and the computer's modem to dial the modem server and gain free access to the Internet.

Other methods may be used to prevent unauthorized devices or computers from gaining unauthorized access to the remote server system. For example, one reasonable measure for security would be to have the initial authentication conversation between the call indicator device and the remote server system occur on one specified TCP port number. Then if the initial authentication routine proves successful, the call indicator system may be instructed to connect to a different TCP port number for the audio file downloads and configuration changes. Additionally or alternatively, both the call indicator device 12 and the remote server system 18 may be adapted to keep track of the number of times a connection has been made between a given call indicator device 12 and the remote server system 18. A comparison of the number of connections may be used as part of the authentication process, such as forming part of an authentication string. Additionally, a comparison of the number of successful connections may serve to confirm that the call indicator device and the remote server system are in sync.

As an additional or alternative security measure, the call indicator devices of the present disclosure may be adapted to use simple algorithms and strings to authenticate the call indicator device attempting to connect with the remote server system. For example, a bitwise XOR of the serial number, or some other secret number permanently stored on device 12, may be compared to an authentication string from remote server system. Additionally or alternatively, the authentication string from the call indicator device may include a dynamic portion that is changed by the remote server system at the end of each download session to be known only by the call indicator device 12 and the remote server system 18. An additional or alternative variation on this algorithm and authentication string security method may include a software function programmed into the call indicator device 12. For example, the call indicator device may be configured to perform one or more operations on a string of characters passed to it by the remote server system at the beginning of the download session and to pass back a computed result that would be compared with the expected value at the remote server system. Using simple algorithms like these or other suitable security configurations may provide several different opportunities to discourage other devices from connecting to service of the present disclosure without proper authentication.

The security of the landline-telephone personalization systems may additionally or alternatively be improved through the use of a login-type procedure for authentication of the call indicator device. In some implementations, the connection between the modem server 20 and the call indicator device 12 may be configured to require a user id/password login from the call indicator device prior to initiating the download, which may add a layer of security for authentication. An AAA server, such as a Radius server 850 may be incorporated in the remote server system 18 to accommodate and authenticate the many userid/password pairs. The call indicator device 12 attempting to connect to the remote server system may answer the login prompt with the serial number of the call indicator device as the user-id and a password which could be a secret security string stored on device 12, such as the static or dynamic strings described above.

Users of the call indicator devices 12 of the present disclosure will likely want to use the same audio files on multiple call indicator devices that they own, such as one for the family room and one for the bedroom. In some configurations, the user may be required to purchase multiple downloads of the same file or otherwise obtain permission to use the same audio file on two devices. The operator of the present systems and methods may allow unlimited downloads of audio files uploaded by the user but may desire to restrict the downloads of pre-recorded audio files. One simple method of restricting the downloads would be to require the user to register each call indicator device they own with a user account on the remote server system. The user could then have a single-user license to download purchased audio files to all of his/her call indicator devices. The authentication procedures described above could be used to verify that the downloads are only going to devices on the user account.

However, some users might be inclined to register devices that belong to other people under the user's account, such as friends or extended family. One suitable method of countering this possibility includes verifying the location from which the call indicator device is connecting when it calls in to the remote server system to download audio files. For example, in some implementations, comparing the calling line ID of the line from which the call indicator device is connecting to remote server system with the home or base telephone number of the user may be one way of verifying that all of device serial numbers entered into a user's profile actually belong to that person (or family) and not to some of their friends. However, such methods would not prevent the friend from bringing a device to a user's home and initiating a download session from the user's home and returning the call indicator device to the friend's home for use in the playback mode. In some configurations of the call indicator devices 12 within the scope of the present disclosure, the device may be adapted to periodically and randomly attempt to connect with the remote server system without user interaction. These automatic connections to the remote server system 18 may be adapted to include a simple calling line ID check to confirm that the device is being used in playback mode on the same phone line through which it downloaded the audio files. In the event that there is a match, the connection will terminate and the confirmation may be recorded. In the even that the calling line ID in playback mode does not match the calling line ID of the download mode, the remote server system 18 may be adapted to disable the call indicator device 12. The call indicator device 12 may be adapted to display an error status indicator to encourage the user of the call indicator device to log on to his/her account to check the status and interact with the operator of the remote server system to resolve the detected error. To reduce the possibility of a long-distance charge to the user, the automatic connection sessions may be adapted to always use a toll-free number.

The systems and methods of the present disclosure may include a software component to facilitate the configuration of call indicator devices 12. The software component may be operated on a computer 16, as discussed above. The software component may be locally installed on the computer 16 or may be provided via a web-based software interface. The software component may be used to create and organize voice and music audio files and announcements, to create and manage a list of caller IDs, and to associate each caller ID or group of caller IDs with one or more voice/music audio files. The software component may provide the ability to easily create customized sound files of spoken names or other recorded audio expressions that can be used to identify the caller in a more personalized or entertaining manner.

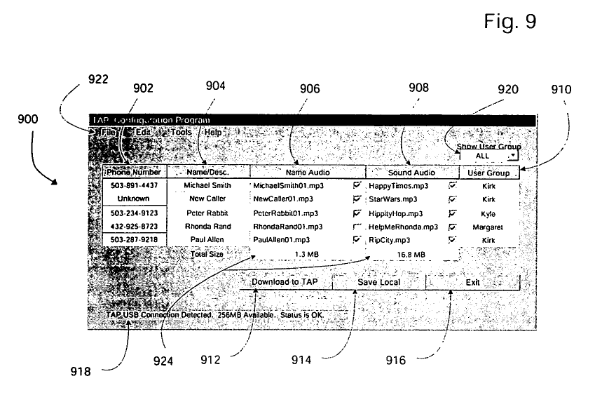

FIG. 9 provides an illustration of a screen shot 900 of one example of a software component as it might appear on the screen of personal computer 16. The screen shot illustrated in FIG. 9 is one illustration of a user interface to assist the user in creating a caller audio database of caller IDs and desired announcement behavior. The discussion of FIG. 9 along with the remaining discussion of this disclosure illustrates that many other user interfaces and database interfaces may be implemented.

In the illustrated screen shot of FIG. 9, the software component follows the standard software application conventions of providing a main menu across the top of the screen, though other suitable conventions may be implemented. The area below this main menu is a simple grid format in which the user is allowed to edit the cells to create and edit the configuration entries. In addition to allowing the user to directly type data into the cells, the values and file names may be pasted from the standard MS Windows clipboard using MS Windows standard editing functions and may be capable of drag-and-drop placement and specification of these items as well.

With continuing reference to FIG. 9, the Phone Number column 902 contains a phone number, which may be entered into the field by the user. In some configurations including a caller ID module, the call indicator device may be adapted to upload a list of recent or frequently calling numbers to the remote server system to prompt the user to configure the audio file that will be played when those numbers call again. When programmed into-call indicator device 12, the caller ID of the incoming call may be compared with the numbers in this column, and if a match is found, the announcements may be audibly played by device 12 per the associated configuration settings for this matching number. The user may also enter “Unknown” into the rows of this column and proceed with defining how calls from numbers not in the list are to be handled by setting the other attributes for this row on the screen shown. Alternatively, the software component may provide an additional screen where the behavior of the call indicator device 12 is configured for numbers that are not in the database.

The Name/Desc. column 904 contains a text description that the user gives to the corresponding telephone number. This column can be used to organize and sort the phone numbers by name or description. The Name/Desc. column may also be used for text-to-speech functionality if the user's call indicator device 12 is so equipped. The text-to-speech functionality may use this customized caller name field as the text that is converted to speech rather than the caller ID information sent by the telephone company.

The Name Audio column 906 contains the name of a digital audio file, which may be the spoken pronunciation of the caller's name as written in the Name/Desc. column and corresponding to the telephone number in the first column. Depending on the manner of implementing the software component, this column may include a link to the location where the audio file is stored and/or may enable the user to upload an audio file to the remote server system for later download to their call indicator device. The user may record the audio contained in this file themselves or may upload other audio content contained on their computers. In one embodiment of the software component, the recording of digital name audio can be done directly through the application software. A computer 16 with a sound card and a microphone can be used to enable a user to record a custom audio file. While the column is labeled Name Audio and may be intended for storage of an audible announcement of the caller's name, users may be able to associate these fields with any suitable audio file, including music files.

The check box in the Name Audio column 906 may allow the user to enable or disable the playback of this audio when the associated caller calls. Accordingly, the call indicator device 12 may be adapted to play multiple audio files for some callers and fewer audio files for other callers. For example, a user may desire a name announcement and a music announcement for some callers and only a music announcement for other callers. Additionally or alternatively, each row of the grid, and therefore each caller in the caller audio database, may include a field allowing a numeric entry to specify the number of times that the digital audio may be repeated before silencing the call indicator device.

The Sound Audio column 908 contains the name and/or path of a second digital audio file, which may be played by the call indicator device 12 immediately after the Name Audio file has finished playing. As with the Name Audio column 906, this column may enable the user to identify where the software can find the designated file, to upload the file to a remote content server, and to otherwise configure the file for synchronization with the call indicator device 12. This second digital audio file may be played repeatedly until either the caller hangs up or the user answers the incoming call. Additionally or alternatively, the second digital audio file specified in the Sound Audio column 908 and the first audio file specified in the Name Audio column 906 may repeat in a predetermined or in a random order. The recording and checkbox functionality may be the same as for the Name Audio of the preceding column. The audio files to be played, as designated by the entry in this column, may be enhanced 3-dimensional sounds such as that produced by VR Sound or other enhanced sound technologies which add depth and realism to the audio produced.

The entries in the User Group column 910 allow the user to group the rows in the grid according to the values entered in this column. One application of the User Group column would be to associate several caller ID entries with a particular user or with a particular instance of call indicator device 12. There may be several instances of call indicator device 12 deployed in a home or other typical implementation and each device may be configured with a different caller audio database according to the callers of interest to the users. For example, the call indicator device in the child's bedroom may have a different set of audio files and callers of interest than the call indicator device located in the home office. Such an implementation would enable a user to silence the phone in the home office for all calls except those from clients and would enable the user to silence the phones in the remainder of the home when the incoming call is from a client. Similar and analogous applications may be desirable by families of different circumstances.

The overall caller audio database managed by the software component of the present disclosure may include the caller audio databases for all of call indicator devices 12 employed by a user or homeowner, with each of the caller audio databases being organized into user groups by the name of the user. When the user chooses to download the caller audio database to a call indicator device 12, such as by clicking the “Download to TAP” button, the user may be prompted to select one of the listed User Groups thereby determining the subset of the caller audio database that is downloaded to the call indicator device 12. This way multiple devices deployed in a household can each be set to respond differently to a particular calling number or to not respond at all.

The software component may provide other methods of configuring multiple devices in a single user group. For example, there may be a master account and several sub-accounts such that each user is able to configure their own lists. Moreover, the sub-accounts may be associated with particular instances of call indicator device 12, such as by associating the sub-account with a device serial number, such that the user's synchronization of call indicator device 12 with the software component may automatically determine which audio files and configuration settings to synchronize.

The “Download to TAP” button 912 may open a download dialog screen and prompt the user to select one user group from a list of all the possible user groups thereby specifying that the configuration entries for just that particular user group are to be downloaded to a call indicator device. In implementations where the call indicator device 12 connects to the remote server system 18 via the telephone line, the “Download to TAP” button may open a screen for finalizing the configuration settings and preparing the configuration data and audio files for synchronization with call indicator device 12 the next time it is connected to the remote server system 18. The buttons and screens used to finalize the configuration settings and prepare the changes for synchronization with call indicator device 12 may vary. FIG. 9 is one example of an implementation of a software tool for illustration.

The status of the download or synchronization may be displayed to the user confirming a successful download, such as by visual indicators on call indicator device 12 and/or by indicators displayed by the software component. The systems and methods of the present disclosure may be configured to only enable the download or synchronization if the call indicator device 12 is determined to have enough memory to store the selected files and other configuration parameters for download. The determination of the available memory on the device may be made by comparing the selected changes with the last known configuration of the call indicator device stored by the remote server system. Additionally or alternatively, the call indicator device 12 may be instructed to transmit its current configuration to the remote server system at the outset of the download operating mode to confirm that the remainder of the download operation will be able to complete successfully. If there is not enough memory in the call indicator device 12, the user may be instructed to adjust their configuration so that it may fit into the memory space available. The user may be advised of the storage space failure either through the software component or through visual indicators on the call indicator device 12 depending on how the storage capacity is determined. Another option of purchasing and installing additional memory, such as flash memory, may also be presented to the user through the software component.

The “Save Local” button 914 may open a standard save file dialog screen allowing the user to save the contents of the caller audio database and/or other configuration details to a local file for backup and later retrieval. This essentially stores the configuration files on the user's local PC so they can be used again and/or edited in the future. Similar configuration file save functionality may be implemented in a number of suitable manners. Additionally or alternatively, the user may be able to save the configuration files to the remote server system. Similarly, the last synchronized configuration settings may be automatically saved to a remote server as described above.

The “Exit” button 916 may cause the software component to close and exit. In implementations including a login functionality, the “Exit” button may additionally log the user off of the software component. If changes have been made to any of the configuration files since the save function was last initiated, the user may be prompted to save these new changes before exiting.

The status bar 918 at the bottom of the screen may display general status information as well as specific status messages depending upon the action being taken and the context of this action. Some of the typical status messages displayed may relate to the connection from the personal computer 16 to call indicator device 12, the connection from the personal computer 16 to the Internet and the remote server system, the connection from call indicator device 12 to the remote server system, the status conditions and memory capacity of the connected device, and the general status regarding operation of the software component. Other suitable status messages may also be displayed.

The “combo drop-down” control 920 labeled “Show User Group” may allow the user to display only those rows in the grid where the User Group entry matches the entry herein selected. The purpose of this control is to allow the user to display entries one-group-at-a-time if desired. Similar sorting features may be implemented to sort by other criteria.

The menu 922 across the top of this screen shows that this software application may have main menu selections of “File”, “Edit”, “Tools” and “Help”. These menus may contain submenus and selections typical for Microsoft Windows based applications that allow the user to save their configurations, edit saved configurations, cut and paste entries from within the application as well as from other external applications and other functions typical to similar applications. Additional menu items and submenu items may be utilized as desired.

As indicated above, FIG. 9 provides a screen shot of an exemplary user interface for a software component that may be provided as part of the present systems and methods. The software component may include additional or different features and/or functionality depending on the configuration of call indicator device 12.

It is believed that the disclosure set forth above encompasses multiple distinct inventions with independent utility. While each of these inventions has been disclosed in its preferred form, the specific embodiments thereof as disclosed and illustrated herein are not to be considered in a limiting sense as numerous variations are possible. The subject matter of the inventions includes all novel and non-obvious combinations and subcombinations of the various elements, features, functions and/or properties disclosed herein. Where the disclosure or subsequently filed claims recite “a” or “a first” element or the equivalent thereof, it should be within the scope of the present inventions that such disclosure or claims may be understood to include incorporation of one or more such elements, neither requiring nor excluding two or more such elements.

Applicant reserves the right to submit claims directed to certain combinations and subcombinations that are directed to one of the disclosed inventions and are believed to be novel and non-obvious. Inventions embodied in other combinations and subcombinations of features, functions, elements and/or properties may be claimed through amendment of the subsequently filed claims or presentation of new claims in that or a related application. Such amended or new claims, whether they are directed to a different invention or directed to the same invention, whether different, broader, narrower or equal in scope to the original claims, are also regarded as included within the subject matter of the inventions of the present disclosure.

I claim:

1. A call indicator device to be used with a computer having a first IP address, the call indicator device comprising:
a speaker for producing audio announcements from one or more audio files;
a processor for executing program instructions;
a modem including a communications port adapted to connect to a public switched telephone network (PSTN); and
memory for storing audio files and program instructions;
wherein the device is adapted to operate in a download mode to establish a TCP/IP connection using a second distinct IP address over the PSTN; and to download one or more audio files from a remote audio file archive over the TCP/IP connection to the memory of the device; wherein the one or more audio files were selected by a user via the computer using the first IP address; and
wherein the device is adapted to operate in a playback mode to detect incoming calls; to select one or more audio files from memory; and to play the selected audio files to indicate the incoming calls.

2. The call indicator device of claim 1 wherein the device further includes a visual indicator consisting essentially of one or more LED lights.

3. The call indicator device of claim 1 wherein the device further includes a visual indicator comprising a visual display adapted to indicate call status and function status.

4. The call indicator device of claim 1 wherein the device includes a telephone line jack adapted to connect a landline telephone to the PSTN through the call indicator device.

5. The call indicator device of claim 1 wherein the call indicator device further includes a data port for communicating with a local computer.

6. The call indicator device of claim 1 further comprising a caller ID module configured to determine the calling line ID (CLID) of an incoming call.

7. The call indicator device of claim 6 wherein during the playback mode of operation the device is adapted to select an audio file based at least in part on the determined CLID of the incoming call.

8. A landline-telephone personalization system comprising:
a call indicator device, adapted to be assigned a first IP address, and configured to download audio files over a public switched telephone network (PSTN) and to play audio files to indicate incoming calls through the PSTN;
a computer, adapted to be assigned a second distinct IP address, and configured to enable a user to view and select audio files available for download to the call indicator device; and
a remote server system configured to establish a TCP/IP connection with the call indicator device using the first IP address over the PSTN and to establish a connection with the computer using the second IP address through an internet service provider;
wherein the remote server system is configured to present at the computer the availability of one or more audio files for selection by a user, to log at the remote server system audio files selected by the user at the computer, to index the selected audio files to one or more call indicator devices, and to download the selected audio files to the indexed call indicator devices.

9. The landline-telephone personalization system of claim 8 further comprising a landline telephone for receiving calls;

10. The landline-telephone personalization system of claim 8, wherein the remote server system includes a modem server adapted to receive TCP/IP connections from the call indicator device and to download audio files from the remote server system.

11. The landline-telephone personalization system of claim 8 wherein the computer and the remote server system are cooperatively adapted to allow the user to establish a user account with the remote server system, to index the user account to one or more call indicator devices, and to select one or more audio files for download to one or more of the indexed call indicator devices from the remote server system through web pages viewed on the computer.

12. The landline-telephone personalization system of claim 11 wherein the computer and the remote server system are further adapted to allow a user to index one or more calling line ID's (CLID's) to user-selected audio files, wherein the call indicator device is configured to download the index of CLID's and user-selected audio files over the PSTN; wherein the call indicator device includes a caller ID module configured to determine the calling line ID (CLID) of an incoming call, and wherein the call indicator device is configured to select audio files for playback to indicate incoming calls based at least in part on the determined CLID of the incoming call.

13. A landline-telephone personalization method comprising the steps of:
utilizing a computer having a first IP address to select one or more audio files available at a remote server system and to associate one or more selected audio files with one or more call indicator devices
indexing the selected audio files to the associated call indicator devices at the remote server system;
establishing a TCP/IP connection between a call indicator device and the remote server system over a public switched telephone network (PSTN) using a second, distinct IP address;
downloading the indexed audio files to the call indicator device at the second IP address over the PSTN.

14. The method of claim 13 further comprising playing an audio file on the call indicator device to indicate an incoming call over the PSTN.

15. The method of claim 14 further comprising:
using the computer to create a calling line ID (CLID) index on the remote server system associating one or more calling line ID's to one or more audio files;
downloading the CLID index to the call indicator device over the PSTN;
determining the CLID of an incoming call to the call indicator device through the PSTN; and
selecting an audio file to indicate the incoming call based at least in part on the determined CLID of the incoming call.
